(19) United States
(12) Patent Application Publication
(10) Pub. No.: US 2007/0017355 A1
(43) Pub. Date: Jan. 25, 2007

(54) ELECTROMAGNETIC MUSICAL PICKUP WITH HUM REJECTING SHIELDS

(76) Inventor: Melvin A. Lace, Prospect Heights, IL (US)

Correspondence Address: ROMI N. BOSE, 1157 BANYON CT., NAPERVILLE, IL, 60540, US

(21) Appl. No.: 11/459,338

(22) Filed: Jul. 22, 2006

Related U.S. Application Data
(60) Provisional application No. 60/702,112, filed on Jul. 25, 2005.

(51) Int. Cl. G10H 3/14

(52) U.S. Cl. 84/728

(57) ABSTRACT

A new and improved electromagnetic pickup for a musical instrument having a plurality of ferromagnetic strings includes an elongated ferromagnetic core and an elongated, annular, electrically conductive pickup coil disposed in encompassing relation to the core to enable the pickup to generate a favorable signal-to-noise ratio and to generate signals having a broad range of frequency and “sustain” characteristics.

This application is a continuation application of U.S. Provisional patent application No. 60/702,112, filed on Jul. 25, 2005.

### BACKGROUND

Electromagnetic signal pickups are utilized on musical instruments having ferromagnetic strings. Such pickups have been employed with guitars, bass guitars, banjos, mandolins, violins and a variety of other instruments. A pickup for a musical instrument that uses ferromagnetic strings almost invariably incorporates a magnetic structure for generating a magnetic field that encompasses the strings. That magnetic structure usually includes at least one permanent magnet and may include at least one high-permeability ferromagnetic pole piece. Frequently, the pickup has a separate pole piece or permanent magnet for each string. Thus, a guitar pickup may have six pole pieces or six magnets, one for each string. On the other hand, some electromagnetic pickups have a single pole piece that spans a number of strings, often all of the strings of the instrument. The pickup may have an electrical pickup coil for each string, or it may have one electrical pickup coil that generates a composite all-string signal.

The electrical signals from the coil or coils are amplified and reproduced by a speaker or other transducer that functions as the output of the musical instrument. The electrical pickup coils are customarily disposed in encompassing relation to the magnetic cores. When there are plural coils each coil usually has its own core. This electromagnetic structure is fitted into a housing that may or may not be a part of the magnetic structure. Whether or not it is a part of the magnetic structure, a principal purpose of the housing is to protect the pickup from dirt and other contaminants and to mount the pickup on the instrument.

A wide variety of individual constructions have been used for electromagnetic pickups employed with musical instruments such as guitars. Frequently, the efforts of the pickup designer have been directed toward achieving an output signal from the electrical coil that is as close as possible to a faithful reproduction of the sound that would be developed by the instrument functioning as an acoustical device. This is not always the case, however. Many electromagnetic pickups have been designed to give a particular distortion deemed desirable by the designer or by a musician.

For electromagnetic pickups in general, as applied to musical instruments having steel or other ferromagnetic strings, there may be some difficulty in obtaining an output signal of sufficient amplitude. This may be a minor problem with modem electronic technology, because even a very weak signal can often be amplified to adequate amplitude. On the other hand, reasonable output amplitude from the pickup itself is desirable because it reduces the necessity for subsequent amplification, and thus reduces the likelihood of inadequately controlled distortion. Moreover, with adequate initial amplitude of the signal generated by the pickup, the signal-to-noise ratio is increased so that a “purer” signal can be realized.

A pronounced problem in many electromagnetic pickups for musical instruments has to do with the frequency response. The overall “sound” derived from the output signal is usually critical to the requirements of the musician. Some musicians want to have the output signal as close as possible to the acoustic output of the instrument, at least in theory. Others, however, want to have a distortion that is acceptable to them, one that represents their own concept or technique for interpretation of music. The frequency response characteristics of the pickup are critical in this regard. A similar situation is presented by the sound characteristic known to musicians as “sustain”. Sometimes accented “sustain” is desirable in the view of the musician using the pickup and sometimes it is not.

### SUMMARY

In order to provide a new and improved inexpensive electromagnetic pickup for a musical instrument having a plurality of ferromagnetic strings, there is provided a magnetic shield and a steel shield configured to enable the pickups to generate a favorable signal-to-noise ratio and to generate signals having a broad range of frequency and “sustain” characteristics.

A particular advantage of the pickup of the present invention is the ability to provide a new and improved electromagnetic pickup for a plural ferromagnetic stringed instrument, particularly a guitar, which is quite simple and inexpensive in construction, including a core, a coil, a sensing magnet and magnetic and steel shields, yet that can be readily mounted upon the guitar and has a virtually indefinite life.

Accordingly, the invention relates to an electromagnetic pickup for a musical instrument, such as a guitar, having a plurality of ferromagnetic strings disposed in substantially co-planar spaced relation to each other over a predetermined span S. The pickup includes an elongated ferromagnetic core, having a length L at least about as large as S and a substantially smaller height, and an elongated, annular, electrically conductive pickup coil disposed in encompassing relation to the core.

An elongated, unitary, permanent magnet is disposed underneath the core and the pickup coil. There is no permanent magnet located immediately above the top of the core. Magnetic and steel shields are located on the elongated sides of the coil, substantially spanning the same length as the core. There are no shields on the underside of the permanent magnet.

A housing encompassing the core, the coil, the permanent magnet and the shields, is provided for mounting the pickup on the musical instrument with the core and the coil spanning the ferromagnetic strings in spaced relation thereto and with all strings passing through a magnetic field afforded by the permanent magnet means and the core so that movement of any string (or combination of strings) generates an electrical signal in the coil.

### DESCRIPTION OF THE DRAWINGS

FIG. 1 is a plan view of an electromagnetic musical pickup, specifically a guitar pickup, of the kind to which the invention is directed;

FIG. 2 is a side elevation view of the apparatus of FIG. 1;

FIG. 3 is a section view taken approximately along line 3-3 in FIG. 2;

FIG. 4 is a plan view, with the housing omitted, of an electromagnetic musical pickup such as for an electric guitar, constructed in accordance with one embodiment of the invention;

FIG. 5 is a longitudinal sectional view taken approximately along line 5-5 in FIG. 4;

FIG. 6 is a transverse sectional view taken approximately along line 6-6 in FIG. 4;

FIG. 7 is a transverse sectional view, like FIG. 6, of an alternate embodiment of the invention;

FIG. 8 is a transverse sectional view, like FIG. 7, of another alternate embodiment of the invention;

FIG. 9 is a transverse sectional view, like FIG. 4, illustrating the magnetic fields generated by the electromagnetic musical pickup in accordance with an embodiment of the invention;

FIG. 10 is an isometric view of the electromagnetic musical pickup in accordance with an embodiment of the invention; and

FIG. 11 is an exploded view and a top view of the electromagnetic musical pickup of FIG. 10.

### DESCRIPTION

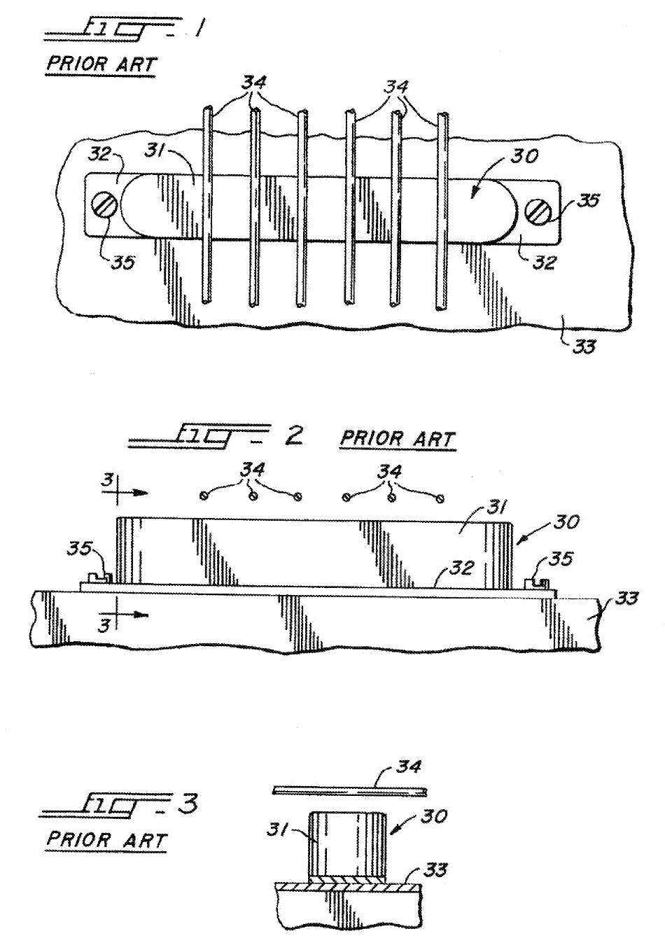

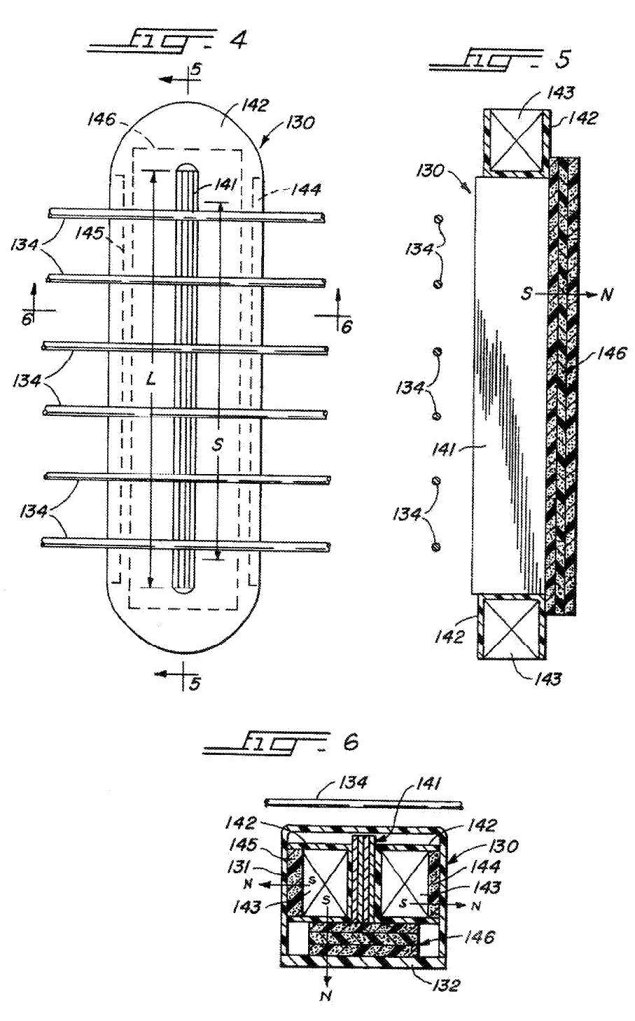

FIGS. 1-3 illustrate an electromagnetic guitar pickup 30 that may be deemed generally representative of prior art pickups but that also applies generally to the electromagnetic musical pickups of the present invention. Typically, pickup 30 comprises a housing 31 having a base plate 32 that may be integral with the housing. Housing 31 may be made of steel or of a permanent magnet material if it is used as an operating component of pickup 30. The housing may be of a magnetically inert plastic if it is not a working electromagnetic component of the pickup. Pickup 30 is mounted on the top 33 of a musical instrument having a plurality of ferromagnetic strings 34. As illustrated, strings 34 are the strings of a guitar and extend across but in spaced relation to the top surface 33 of the guitar neck or body, depending upon where the pickup 30 is mounted. Strings 34 are distributed across a total span S (FIG. 1), usually with approximately equal spacing between the strings. Screws or other appropriate mounting devices 35 are utilized to mount pickup 30 on guitar body 33.

A wide variety of different electromagnetic sensing devices have been utilized in prior art embodiments of pickup 30. Consequently, no specific pickup structure is shown in FIGS. 1-3. On the other hand, it may be noted that any known construction for electromagnetic pickup 30 would include a magnetic structure for generating a magnetic field that encompasses the ferromagnetic strings 34. A structure of this sort, in any of the known prior art devices, customarily includes at least one permanent magnet and may include at least one high permeability ferromagnetic pole piece. For the electromagnetic pickup 30 shown in FIGS. 1-3, utilizing known constructions, there could be six pole pieces, or six magnets, one for each string 34. On the other hand, some forms of electromagnetic pickup have utilized a single pole piece or core that extends the length of the pickup, beneath all of the musical strings 34.

In any of the known forms of electromagnetic pickup there is at least one electrical pickup coil (not shown). There may be separate coils for each of the strings 34, usually with all of those coils electrically connected together. The entire pickup construction, including the pole piece or pieces, the permanent magnet or magnets, and the electrical pickup coil or coils, is disposed in housing 31. Vibrations of the musical instrument strings 34, both vertically and horizontally, generate electrical signals in the coil or coils within housing 31, and it is those signals that are amplified and reproduced, as by one or more speakers, to afford an output from the musical instrument in conventional manner.

As mentioned above, all pickups used on guitars have a magnet and a coil of wire that are appropriately positioned to generate a voltage when the guitar string is moved. However, the improved pickup of the present embodiment includes vastly different sonic and physical properties.

FIGS. 4-6 and 9-11 illustrate the operating components of an electromagnetic-musical pickup 130 constructed in accordance with one embodiment of the present invention. The pickup 130 includes an elongated central ferromagnetic core 141 that extends for a length L that is larger than the string span S. Thus, the core 141 spans all of the ferromagnetic strings 134 of the musical instrument. In this instance, it is assumed that the pickup 130 is used for a six string guitar. However, the pickup 130 easily may be adapted for use with stringed musical instruments having fewer or greater numbers of strings.

As illustrated, the core 141 is made of eight thin sheet steel stabilized magnetic tone alloy laminations. However, the number of laminations may vary. Six or even eight thin steel laminations are frequently utilized. However fewer or greater laminations also may be used to change the tonal characteristics of the sound output from the pickup 130. A coil form or bobbin 142 is mounted on the central laminated core 141 and an electrical pickup coil 143 is mounted in a coil form 142, thus being disposed in encompassing relation to core 141. The pickup coil 143 generates an electrical signal representative of movements of the strings 134 and is a precision wound coil that is calibrated to control output and tone.

An elongated permanent magnet 144 is mounted in the outer edges of the coil form 142 to function as a unique anisotropic flux deflecting magnetic shielding system. More particularly, as shown in FIG. 9, the shielding system includes a thin magnet 144 wrapped around the coil 143, having the same polarity on the coil side as the laminated pole. This configuration causes the magnetic field to become focused and directed at the string 134, resulting in a field pattern 400 that causes far greater accuracy and quality in the reproduced sound. Shaping the magnetic field in this way enables the higher harmonics in the string to be sensed by the pickup 130. Usually, because the harmonics are shorter in wavelength than the fundamental tone and because a magnetic sensor is unable to pickup wavelengths shorter than its window, signal loss is experienced. The pickup 130 of the present invention eliminates such signal loss and produces a much cleaner and fuller sound.

In addition, another advantage of the above described configuration is the increase in the amplitude of the output signal, resulting in greater sound. Furthermore, a major consideration of pickups is the amount of hum, which is also picked up from the ever-present noise fields caused by AC lines etc. Effectively, the use of the magnet 144 wrapped around the coil 143 results in an output increase of about 6 dB, without any increase in hum.

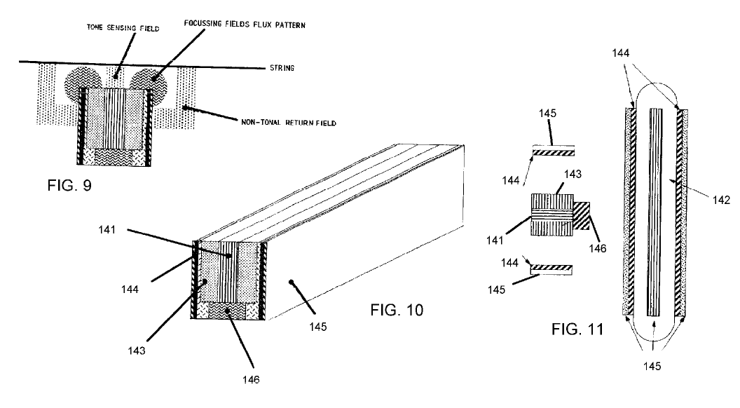

As shown in FIG. 10, in addition to the shielding magnet 144, a steel shield 145 may be placed in contact with the outside of the shielding magnet 144. It should be noted that the steel shield 145 does not extend to the underneath of the pickup 130, but may be configured with a curve to cover the ends of the coil 143. This results in considerable reduction in the hum, with a corresponding increase in the quality of sound. It should further be noted that, as shown in FIG. 11, there is no requirement that the steel shield 145 and the shielding magnet 145 be in contact with the coil 143. It is also to be noted that plastic with metal based plating or plastic with impregnated metal also may be used.

Advantageously, when the steel shield 145 is made out of material with a total cross-section area equal to the laminated pole there is a great reduction of pickup hum. The effective cross-section of the lamination is also influenced by the effective length of the magnet and the effective permeability of the magnet. As such, there is an almost complete overall reduction in hum.

The use of shields, like the steel shield 145, stops the magnetic field from going beyond the coil perimeter, thereby eliminating the effect of any coils outside the steel shield 145. Increasing the vertical height of the steel shield 145 increases its influence. Increasing the thickness of the steel shield 145 yields a similar effect. Furthermore, hum reduction is further slightly increased with an increase in the shield area. The use of the shields also reduces the effect of any shorted turns outside the coil system. For example, the use of a brass cover over a pickup without the magnetic and steel shields has the same effect as almost 1000 shorted turns, which results in a considerable loss of output and a decrease in tonal quality. Significantly, with the shields the effect is zero. That is, the brass cover has no discernable influence on the pickup output, either tonally or sonically. This is the result of the variable magnetic gap being isolated to only the area over the core (FIG. 9). If a brass cover is used, a separate ground wire may be provided to allow ease of phase reversal of the pickup.

As particularly shown in FIG. 10, the lower elongated edge of the laminated steel core 141 engages the top surface of an isotropic main permanent magnet 146. The main permanent magnet 146 may be constructed of several layers of permanent magnet material commercially available in thin sheets or of unitary construction (as illustrated). If made of several layers, all the layers of the permanent magnet 146 are magnetized in the same direction, transverse to the height of the core 141. This enables a continuous south pole facing upwardly of the magnet 146 and engaging the lower edge surface of the laminated core 141. The entire pickup 130 may be encompassed in a housing 131 and supported upon a base 132. The housing 131 and base 132 may constitute plastic moldings, since the housing is not a part of the magnetic structure in the pickup 130.

The preferred permanent magnet material, for the shield magnet 144 as well as the main permanent magnet 146, comprises a resin material, preferably relatively flexible and slightly elastomeric, that is impregnated with particulate permanent magnet material. Such permanent magnet resin sheets are readily available commercially. One form of flexible permanent magnet resin material is made and sold by Arnold Company under the trademark PLASTIFORM. Another flexible resin permanent magnet material that may be utilized in the device 130 for the permanent magnets is made and sold by RJF International Corporation under the trademark KOROSEAL. Yet another such material is available from The Electrodyne Company under the designation PLASTALLOY for material with a moderate induction level. Similar material with a higher induction level (maximum energy product is sold by that company under the designation REANCE 90. The preferred wire size for the coil 143 ranges from 38 to 44 gauge copper wire. Larger wire sizes result in better high frequency response. For the core 141, No. 1008 steel is satisfactory.

The electromechanical musical pickup 130 of FIGS. 4-6 and 9-11 produces a rather surprisingly high amplitude output signal, usually three to four times the amplitude obtainable with previously known pickups, particularly guitar pickups. All of the materials employed in the pickup 130 are commercially available, although the coil 141 is usually wound to a particular specification and the dimensions of the core laminations must also be established. Typically, the laminations of the core 141, in a guitar pickup, may have a length L of 2.22 inches (5.64 cm), a height of 0.34 inches (0.86 cm) and a thickness of 0.02 to 0.025 inches (0.125 cm). Typically, the permanent magnet layers are No. 1008 steel, approximately 0.03 inches (0.075 cm) in thickness.

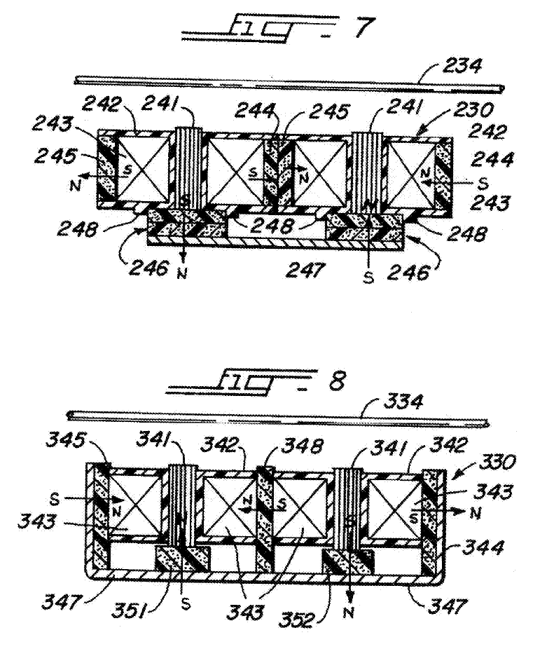

FIG. 7 illustrates another electromagnetic musical pickup 230 constructed in accordance with the invention, in a view similar to FIG. 6 but omitting the housing. In many respects pickup 230 of FIG. 7 is a dual coil or “humbucker” version of the construction illustrated in FIGS. 4-6. Thus, it includes two laminated ferromagnetic cores 241 on which two coil forms 242 are mounted. There are two electrical pickup coils 243 in the pickup 230. In each side of the humbucker pickup 230 there is an elongated permanent magnet 244, used as a shield magnet and mounted in the outer portion of the coil form 242 for one side of the pickup. A steel shield 245 is also mounted along the outside of the permanent magnet 244, but specifically is not wrapped around the bottom of the permanent magnet. The permanent magnet 244 of the pickup 230, as seen in FIG. 7, is magnetized transversely so that the surface of the permanent magnet shield facing the coil 243 on this side of the pickup presents a continuous south pole facing toward the coil. The construction is the same but the polarization of the permanent magnets is opposite on the right-hand side of the humbucker pickup 230, so that the coil 243 on this side of the device faces a north pole for the shield magnet 244.

Immediately below each of the laminated sheet steel cores 241 in the pickup 230 as shown in FIG. 7, there is a permanent magnet 246. The permanent magnets 246 are shown as each having two layers of permanent magnet material. They could be three layers as shown in FIG. 6 or, when thicker permanent magnet material is available, each of the permanent magnets 246 may be of unitary, integral construction. The permanent magnet 246 at the left-hand side of the pickup 230 is magnetized to present a continuous south pole on the upper surface of the magnet that engages the lower longitudinal edge of the core 241 at this side of the pickup. The other main permanent magnet 246, at the right-hand side of pickup 230, is of similar construction but is magnetized so that its upper surface, engaging the lower edge of the associated core 241, is a north pole. The steel sheet 245 extends across only the sides of the pickup and does not cover either the bottom of the pickup 230 or the permanent magnets 246. Coil bobbins 242 may be provided with depending projections 248 to facilitate alignment of the magnets 246 with their associated laminated cores 241.

With the coils 243 connected to each other in a conventional coplanar humbucker configuration, as shown, the signal-to-noise ratio of the pickup 230 is high and there is virtually no hum in the output signal from the pickup coils 243. The desired signal output from the device 230, however, produced by vibration of one of the ferromagnetic strings 234 in the magnetic field of the pickup, is appreciably higher in amplitude than with conventional humbucker pickups. Indeed, an increase in amplitude of three to four times is readily realized. Moreover, the pickup 230 is protected against internal vibrational feedback and microphone effects by the auxiliary shield magnet 244. A steel sheet is mounted on the outside of the shield magnet 244, as described in regards to the pickup 130 mentioned above. The base 247 may constitute plastic moldings.

A further modification of pickup 230, FIG. 7, entails reversing of one main permanent magnet 246 to have the same polarization as the other main magnet. The outer shield magnet for that same side of the pickup should also be reversed in polarization. A steel shield is also provided on the outside of the shield magnet. The result is a pickup that still has a higher amplitude output and is still protected against vibrational feedback and microphonic effects by the shield magnets 244 and 245.

Yet another electromagnetic musical pickup 330, constructed in accordance with a further embodiment of the invention, is shown in FIG. 8, again in a view comparable to that of FIGS. 6 and 7. In the pickup 330, which is shown as a humbucker pickup, there are again two elongated laminated ferromagnetic cores 341 each encompassed by a coil form or bobbin 342 with an electrical pickup coil 343 mounted in the bobbin at each side of the pickup. The pickup 330 is disposed within a sheet steel casing 347 that is open at the top and the bottom sides. The casing 347 may constitute a part of the pickup housing, requiring only a lid (not shown) to enclose the entire pickup. A permanent magnet shield 344 is mounted in the right-hand side of the pickup 330, between the vertical wall of the casing 347 and the coil 343. Similarly, a permanent magnet shield 345 is disposed adjacent to the left vertical wall of the casing 347, between the casing and the second coil 343. The permanent magnets 344 and 345 are polarized so that one of the magnets 344 presents a continuous south-pole face to the coil 343, whereas the other permanent magnet 345 presents a continuous north-pole face immediately adjacent its coil 343.

The pickup 330 further includes two main permanent magnets 351 and 352 in the base of the pickup. One of the permanent magnets 351 is located at the left-hand side of the pickup, as shown in FIG. 8, immediately below the laminated ferromagnetic core 341 at the left-hand side of the pickup. This permanent magnet 351 is polarized, as shown, to present a north-pole surface engaging the lower surface of the core 341. The other permanent magnet 352 is similar except that it engages the other laminated core 341 at the right-hand side of the pickup 330 and presents a continuous south-pole surface in engagement with that core. Thus, the pickup 330 is a “humbucker” pickup.

At the center of the pickup 330 there is one more permanent magnet 348. This permanent magnet is magnetized transversely to present a continuous north pole facing toward the left-hand half of the pickup and a continuous south pole facing the right-hand portion of the pickup.

Like the previously described dual coil humbucker pickup of FIG. 7, the humbucker pickup 330 of FIG. 8 generates a high amplitude output signal from its interconnected coils 343. If those two coils are connected in the usual humbucker configuration so that they cancel extraneous hum or noise, the output signal developed in response to vibration of any of the ferromagnetic strings 334 is of substantial amplitude but has little or no hum content. The signal-to-noise ratio is excellent. As in the case of the pickup shown in FIG. 7, the auxiliary or shield permanent magnets 344, 345 and 348 shield the two coils 343 of the pickup. Also, the entire pickup 330 may be encompassed in a housing 347. The housing 347 may constitute plastic moldings, since the housing is not a part of the magnetic structure in the pickup 330.

It will be apparent to those skilled in the art that various modifications and variations can be made in the electromagnetic pickup of the present invention without departing from the scope or spirit of the invention.

What is claimed is:

1. An electromagnetic pickup for a musical instrument, such as a guitar, having a plurality of ferromagnetic strings disposed in co-planar spaced relation to each other over a predetermined span S, the pickup comprising:
an elongated ferromagnetic core;
an electrical pickup coil disposed in encompassing relation to the core;
a main magnet disposed in engagement with one elongated edge of the core and magnetized in a direction parallel to the height of the core, for maintaining a given constant polarity in the core;
a first shield surrounding the sides of the core; and
a second shield surrounding the first shield.

2. The pickup of claim 1, wherein the first shield is curved to cover the ends of the coil.

3. The pickup of claim 1, wherein the first shield is made of a magnetic material.

4. The pickup of claim 1, wherein the second shield is curved to cover the ends of the coil.

5. The pickup of claim 1, wherein the main magnet is manufactured of a magnetic material.

6. The pickup of claim 1, wherein the main magnet may be a permanent magnet.

7. The pickup of claim 1, wherein a separate coil is placed around the pickup when the shields are used for enabling the pickup to operate as a humbucking pickup.

8. The pickup of claim 1, further comprising a brass cover and a separate ground wire to allow ease of phase reversal of the pickup.

9. The pickup of claim 1, wherein the shield surrounding the magnetic shield contains metal.

10. The pickup of claim 1, wherein the shield surrounding the magnetic shield is made of steel.

11. An electromagnetic pickup for a musical instrument, such as a guitar, having a plurality of ferromagnetic strings disposed in co-planar spaced relation to each other over a predetermined span S, the pickup comprising:
a ferromagnetic core;
an electrical pickup coil disposed in encompassing relation to the core;
a main magnet disposed in engagement with one edge of the core and magnetized in a direction parallel to the height of the core, for maintaining a given constant polarity in the core;
a first shield surrounding the sides of the core; and
a second shield surrounding the first shield.

12. The pickup of claim 11, wherein the shield surrounding the magnetic shield contains metal.

13. The pickup of claim 11, wherein the shield surrounding the magnetic shield is made of steel.

14. The pickup of claim 11, wherein the main magnet is manufactured of a magnetic material.

15. The pickup of claim 11, wherein the main magnet is a permanent magnet.
